(19) United States
(12) Patent Application Publication
(10) Pub. No.: US 2024/0104341 A1
(43) Pub. Date: Mar. 28, 2024

(54) MEMORY OPTIMIZATION METHOD AND APPARATUS FOR NEURAL NETWORK COMPILATION

(71) Applicant: ZHEJIANG LAB, Hangzhou (CN)

(72) Inventors: Hongsheng WANG, Hangzhou (CN); Guang CHEN, Hangzhou (CN); Lingfang ZENG, Hangzhou (CN)

(21) Appl. No.: 17/992,822

(22) Filed: Nov. 22, 2022

Related U.S. Application Data
(63) Continuation of application No. PCT/CN2022/124003, filed on Oct. 9, 2022.

(30) Foreign Application Priority Data
Sep. 27, 2022 (CN) 202211177784.6

(51) Int. Cl. G06N 3/04

(52) U.S. Cl. CPC G06N 3/04

(57) ABSTRACT

A memory optimization method includes: compiling a neural network into a computational graph for neural network computation on a computer; transforming the computational graph into a topological graph; constructing a life cycle relationship graph of tensor variables in the computational graph; and analyzing a life cycle relationship among tensor variables in a node of the computational graph; iteratively merging those tensor variables connected by lines of the second type and caching into a memory any tensor variable that goes beyond a number of idle registers and is not allocated to a register, until all tensor variables that go beyond the number of the idle registers and are not allocated to registers are cached into the memory; caching any node of the life cycle relationship graph with a degree smaller than a number of registers into a stack.

The present application claims priority to Chinese Patent Application No. 202211177784.6 filed in China National Intellectual Property Administration on Sep. 27, 2022, entitled “MEMORY OPTIMIZATION METHOD AND APPARATUS FOR NEURAL NETWORK COMPILATION”, the entire contents of which are incorporated herein by reference.

### TECHNICAL FIELD

The present disclosure relates to the technical field of a computer based on a specific computing model, and particularly, relates to a memory optimization method and apparatus for neural network compilation.

### BACKGROUND

As super-large neural network models in the field of natural language processing are released successively in recent years, the outstanding performance of these super-large models on a natural language processing task enables these super-large models to increasingly be the future development trend. However, it brings the challenge that a memory required for training the super-large models on artificial intelligence hardware cannot be solved, so it becomes extremely important to optimize a memory for neural network model compilation. At the same time, the super-large models makes the computer consume more memory resources when the computer processes the task containing the super-large neural network models, and the CPU's register resource consumption is also more strained.

### SUMMARY

The present disclosure aims to provide a memory optimization method and apparatus for neural network model compilation so as to overcome the defects in the prior art.

In order to fulfill the above aim, the present disclosure provides the following technical solution.

The present disclosure discloses a memory optimization method for neural network compilation, including the following steps:
step 1: compiling a neural network into a computational graph for neural network computation on a computer;
step 2: transforming the computational graph into a topological graph;
step 3: constructing an interval graph with respect to a life cycle of a variable included in the computational graph;
step 4: analyzing a life cycle relationship among tensor variables included in a computational graph node;
step 5: merging tensor variables, the life cycles of which have dotted lines, among the tensor variables included in the computational graph node;
step 6: iteratively caching a tensor variable which goes beyond the number of idle registers and is not allocated to a register, into a memory, carrying out merging according to the step 5, and proceeding to the next step, until the tensor variables which go beyond the number of the idle registers and are not allocated to the registers are cached into the memory;
step 7: caching a node with the degree smaller than the number of the registers in a life cycle relationship graph of the tensor variables included in the computational graph into a stack;
step 8: allocating an idle register to a tensor variable which is not allocated to the register and included in a reserved node in the life cycle relationship graph; and
step 9: iteratively allocating a register to a tensor variable included in the node in the stack.

Preferably, the step 2 specifically includes: firstly, sorting sub-graphs of the computational graph in a postorder, and then sorting a sub-graph sequence obtained by the postorder in a reversed order.

Preferably, step 4 includes the following sub-steps:
step 4.1: mutually connecting tensor variables, which have a life cycle overlapping relationship, among the tensor variables included in the computational graph node by solid lines;
step 4.2: mutually connecting tensor variables, which have a life cycle non-overlapping relationship and an assignment relationship, among the tensor variables included in the computational graph node by dotted lines; and
step 4.3: disconnecting edges of tensor variables, the life cycles of which do not overlap with each other, among the tensor variables included in the computational graph node.

Preferably, step 6 includes the following specific sub-steps:
step 6.1: analyzing the life cycles of the tensor variables cached into the memory;
step 6.2: updating the life cycle relationship graph of the tensor variables included in the computational graph node after the tensor variables are cached;
step 6.3: merging the tensor variables, the life cycles of which have the dotted lines, among the tensor variables included in the computational graph node; and
step 6.4: according to step 6.1 to step 6.3, sequentially caching the tensor variables which go beyond the number of the idle registers and are not allocated to the registers into the memory.

Preferably, step 6.2 includes the following specific sub-steps:
step 6.2.1: deleting a node with tensor variables which go beyond the number of the idle registers and are not allocated to the registers in the life cycle relationship graph of the tensor variables included in the computational graph node, and then simultaneously deleting a connecting edge with the node; and
step 6.2.2: updating the life cycle relationship graph by utilizing the node including the cached tensor variables.

Preferably, step 7 specifically includes: sequentially transferring the node with the degree smaller than the number of the registers in the life cycle relationship graph into the stack, until only nodes including the tensor variables, the number equal to that of the idle registers remain.

Preferably, step 9 specifically includes: iteratively allocating a register different from the adjacent node in the life cycle relationship graph to the tensor variable included in the stack where the node is cached, the sequence of allocating the register to the variable included in the node cached into the stack being a process of allocating the registers to the tensor variables sequentially according to a pop sequence of the nodes in the stack.

The present disclosure discloses a memory optimization apparatus for neural network model compilation. The apparatus includes a memory and one or more processors. An executable code is stored in the memory. When executing the executable code, the one or more processors are used for implementing the above memory optimization method for neural network compilation.

The present disclosure has the following beneficial effects. According to the memory optimization method and apparatus for neural network compilation of the present disclosure, a method for optimizing memory allocation of dataflow in the computational graph generated by neural network compilation is provided, and solves the problem of pre-allocating a memory to the tensor variable flowing through each node in the computational graph in the operation process by a deep learning operation system in a compiling phase. The present disclosure provides a method for analyzing the life cycle relationship among the tensor variables included in each node in the computational graph, and provides an optimization method for allocating the memories to the tensor variables included in the computational graph node by analyzing the life cycle relationship among the tensor variables. The memory optimization method for neural network compilation, which is provided by the present disclosure, not only promotes the execution efficiency of the computational graph in the operation process in future, but also reduces the overhead of the tensor variables for memory resources of the deep learning operation system. Therefore, the method for pre-allocating the memory to the tensor variable included in the computational graph node by means of analyzing the life cycle relationship among the tensor variables, which is provided by the present disclosure, optimizes the memory of the dataflow of the computational graph for neural network compilation, reduces the memory overhead required by the tensor variables in the dataflow, and lowers the requirement of a large model for hardware memory resources. According to the present disclosure, the computing efficiency of the overall computational graph is improved, and hardware and time cost is saved.

### BRIEF DESCRIPTION OF FIGURES

FIG. 1 is a computational graph for neural network computation, which is compiled by a neural network;

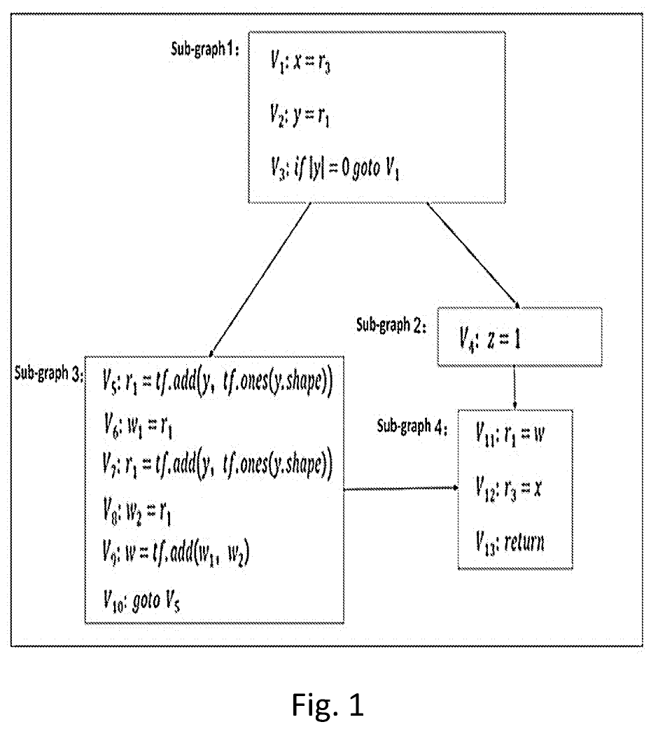

FIG. 2 is a topological structural graph of the computational graph;

FIG. 3 is an interval graph with respect to a life cycle of a variable included in the computational graph;

FIG. 4 shows a process of analyzing a life cycle relationship graph of tensor variables;

FIG. 5 is a schematic diagram showing a process of merging tensor variables r₃ and x, the life cycles of which have dotted lines, among the tensor variables included in the computational graph node;

FIG. 6 is a schematic diagram showing a process of merging tensor variables r₁ and b, the life cycles of which have dotted lines, among the tensor variables included in the computational graph node;

FIG. 7 shows a process of analyzing the interval graph with respect to the life cycle after a tensor variable y which goes beyond the number of idle registers is cached into a memory;

FIG. 8 is a schematic diagram showing a process of deleting a node with the tensor variable cached into the memory and a connecting edge with the node;

FIG. 9 shows a process of updating a life cycle relationship graph by utilizing a node including the cached tensor variable;

FIG. 10 is a schematic diagram showing a process of merging tensor variables, the life cycles of which have dotted lines, among the tensor variables included in the computational graph node;

FIG. 11 is an interval graph with respect to a life cycle after a tensor variable z which goes beyond the number of the idle registers is cached into the memory;

FIG. 12 is a schematic diagram showing a process of deleting a node with the tensor variable z cached into the memory and a connecting edge with the node;

FIG. 13 shows a process of updating the life cycle relationship graph by utilizing the node including the cached tensor variable z;

FIG. 14 is a schematic diagram showing a process of merging a tensor variable z₃, the life cycle of which has a dotted line, among the tensor variables included in the computational graph node;

FIG. 15 is a schematic diagram showing a process of transferring a node with the degree smaller than the number 3 of the registers into a stack;

FIG. 16 is a schematic diagram showing a process of allocating an idle register to a variable included in a reserved node in the life cycle relationship graph;

FIG. 17 is a schematic diagram showing a process of iteratively allocating a register to a variable included in the node cached into the stack; and

FIG. 18 is a schematic diagram of a memory optimization apparatus for neural network compilation according to an embodiment of the present disclosure.

### DETAILED DESCRIPTION

In order to make objectives, technical solutions, and advantages of the present disclosure more apparent, the present disclosure will be further described in detail in connection with the drawings and embodiments. It should be understood that specific embodiments described herein are merely used for explaining the present disclosure, but not used for limiting the scope of the present disclosure. In addition, in the following description, description on the well-known structures and technologies is omitted so as to avoid unnecessary confusion of conceptions of the present disclosure.

The present disclosure provides a memory optimization method and apparatus for neural network compilation. The memory optimization method for neural network compilation provides a method for optimizing memory allocation of dataflow in a computational graph generated by neural network compilation, which solves the problem of pre-allocating a memory to a tensor variable flowing through each node in the computational graph in the operation process by a deep learning operation system in a compiling phase. The present disclosure provides a method for analyzing a life cycle relationship among tensor variables included in each node in the computational graph, and provides an optimization method for allocating memories to the tensor variables included in a computational graph node by analyzing the life cycle relationship among the tensor variables. The memory optimization method for neural network compilation, which is disclosed by the present disclosure, not only promotes the execution efficiency of the computational graph in the operation process in future, but also reduces the overhead of the tensor variables for memory resources of the deep learning operation system.

In the process of developing an algorithm model by researchers and engineers, the model is optimized by utilizing the memory optimization method and apparatus for neural network compilation, the memory overhead required by the tensor variables in dataflow is reduced, the requirement of a large model for hardware memory resources is lowered, and the development of the practical application of a deep neural network model is promoted.

An embodiment of the present disclosure provides a memory optimization method for neural network compilation, including the following steps:
step 1: compiling a neural network into a computational graph for neural network computation on a computer;
step 2: transforming the computational graph into a topological graph;
step 3: constructing an interval graph with respect to a life cycle of a variable included in the computational graph;
step 4: analyzing a life cycle relationship among tensor variables included in a computational graph node;
step 5: merging tensor variables, the life cycles of which have dotted lines, among the tensor variables included in the computational graph node;
step 6: iteratively caching a tensor variable which goes beyond the number of idle registers and is not allocated to a register, into a memory, carrying out merging according to step 5, and proceeding to the next step until all tensor variables which go beyond the number of the idle registers and are not allocated to registers are cached into the memory;
step 7: caching a node with the degree smaller than the number of the registers in a life cycle relationship graph of the tensor variables included in the computational graph into a stack;
step 8: allocating an idle register to a tensor variable which is not allocated to the register and included in a reserved node in the life cycle relationship graph; and
step 9: iteratively allocating a register to a tensor variable included in the node in the stack.

In step 2, the computational graph is transformed into the topological graph. Transforming the computational graph into the topological graph includes two processes:

firstly, sub-graphs of the computational graph are sorted in a postorder; and

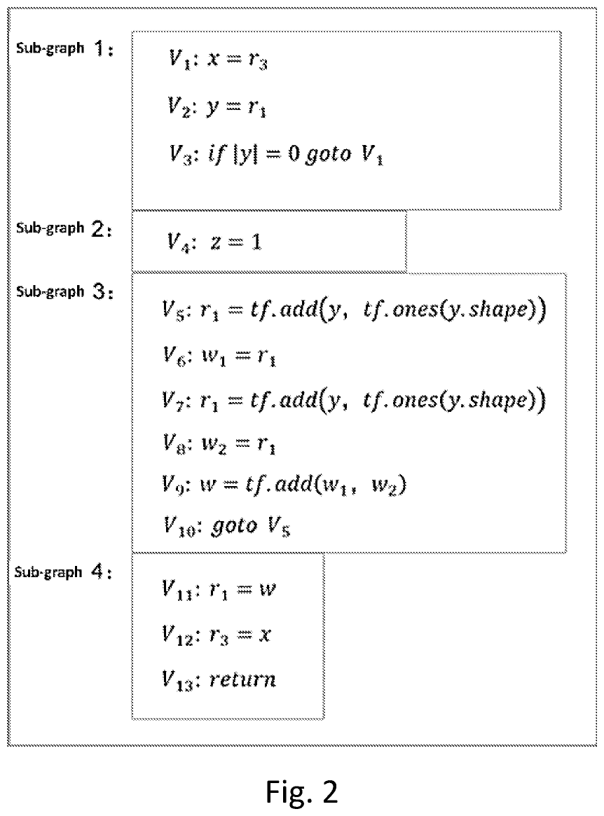

secondly, a sub-graph sequence obtained by the postorder is sorted in a reversed order. FIG. 2 shows a topological structural graph of the computational graph.

Expressions in the figure are explained as follows:

x=a represents that a tensor variable a is assigned to a tensor variable x;

if expression goto Vᵢ represents that whether a value of the expression is true, if yes, a computation flow of a node Vᵢ is executed, otherwise computation flows of other branch nodes are executed;

tf.add(x,y) represents the operation of adding a tensor x and a tensor y;

tf.ones(a.shape) represents the creation of a tensor which has the same shape as the tensor a, and has all elements being 1;

goto Vᵢ represents the execution of the computation flow of the node Vᵢ; and

return represents the returning of a current sub-graph computation result.

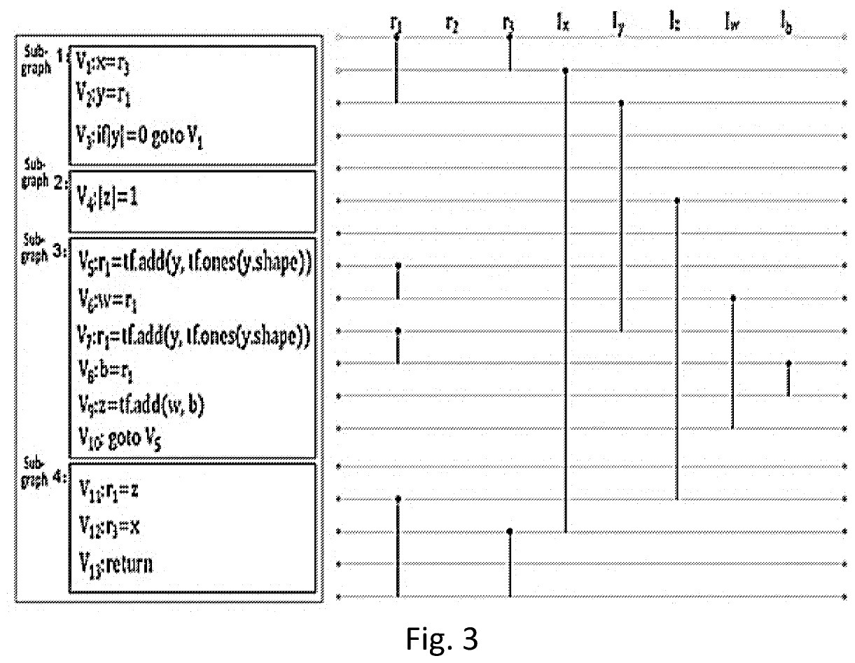

In step 3, the interval graph with respect to the life cycle of the variable included in the computational graph is constructed. From the interval graph, the distribution of the life cycles of the tensor variables required when execution flow in the operation process of the computational graph flows through each node according to a topological sequence can be visually observed, and thus, the relationship among all the tensor variables with respect to the life cycles on the topological structural graph can be efficiently analyzed by means of the interval graph with respect to the life cycle. FIG. 3 shows the interval graph with respect to the life cycle of the variable included in the computational graph.

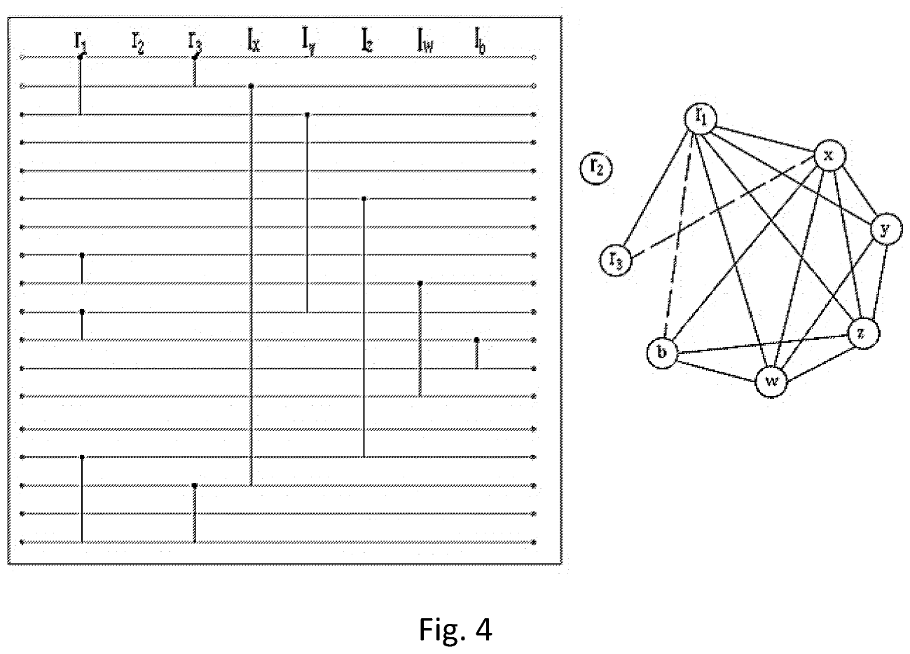

In step 4, the life cycle relationship among the tensor variables included in the computational graph node is analyzed. The right half part in FIG. 4 shows a process of analyzing the life cycle relationship graph of the tensor variables. Analyzing the life cycle relationship among the tensor variables included in the computational graph node includes the following processes:

In a first step, tensor variables, which have a life cycle overlapping relationship, among the tensor variables included in the computational graph node are mutually connected by solid lines. Carrying out edge connection on the tensor variables, which have the life cycle overlapping relationship, among the tensor variables aims to analyze the life cycle relationship of the global tensor variables. By the edge connection condition between the tensor variables, whether the life cycles of two tensor variables mutually conflict is determined. The solid line edge connection represents that the life cycles of the two tensor variables have a mutual conflict relationship. With respect to the tensor variables with the conflict relationship, the two variables need to be allocated to different registers.

In a second step, tensor variables, which have a life cycle non-overlapping relationship and an assignment relationship, among the tensor variables included in the computational graph node are mutually connected by dotted lines. Carrying out dotted line edge connection on the tensor variables, which have the life cycle non-overlapping relationship and the assignment relationship, among the tensor variables aims to analyze the life cycle relationship of the global tensor variables. By the dotted line edge connection condition between the tensor variables, it is determined whether there is no mutual conflict of the life cycles between two tensor variables. The dotted line edge connection represents that the life cycles of the two tensor variables have no mutual conflict, and the tensor variables have the assignment relationship. For two tensor variables which have the life cycle non-overlapping relationship and the assignment relationship, the two tensor variables can be merged and allocated to the same register.

In a third step, edges of tensor variables, the life cycles of which do not overlap with each other, among the tensor variables included in the computational graph node are disconnected. Disconnecting the edges of the tensor variables, the life cycles of which do not overlap with each other, among the tensor variables aims to analyze the life cycle relationship of the global tensor variables. By the condition of no edge connection between the tensor variables, whether two tensor variables have the condition in which the life cycles have no conflict is determined. The condition of no edge connection between two tensor variables represents that the life cycles of two tensor variables do not overlap with each other. For two tensor variables, the life cycles of which have no conflict, the two tensor variables can be allocated to the same register and the two tensor variables are allowed to reuse the same register.

In step 5, tensor variables, the life cycles of which have dotted lines, among the tensor variables included in the computational graph node are merged. Merging the tensor variables, the life cycles of which have the dotted lines, among the tensor variables included in the computational graph node aims to give consideration to two tensor variables whose life cycles do not conflict with each other and that have an assignment relationship. The two tensor variables can be allocated to the same register and then an assignment instruction between the two tensor variables can be deleted. Therefore, tensors with dotted lines in the life cycle relationship graph of the tensor variables are merged.

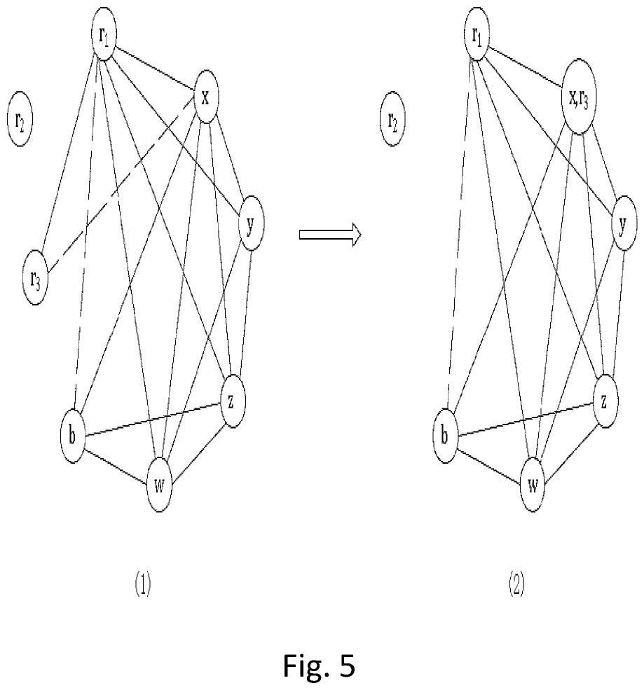

FIG. 5 shows a process of merging tensor variables r₃ and x, the life cycles of which have dotted lines, among the tensor variables included in the computational graph node, e.g., the process from (1) to (2) in FIG. 5.

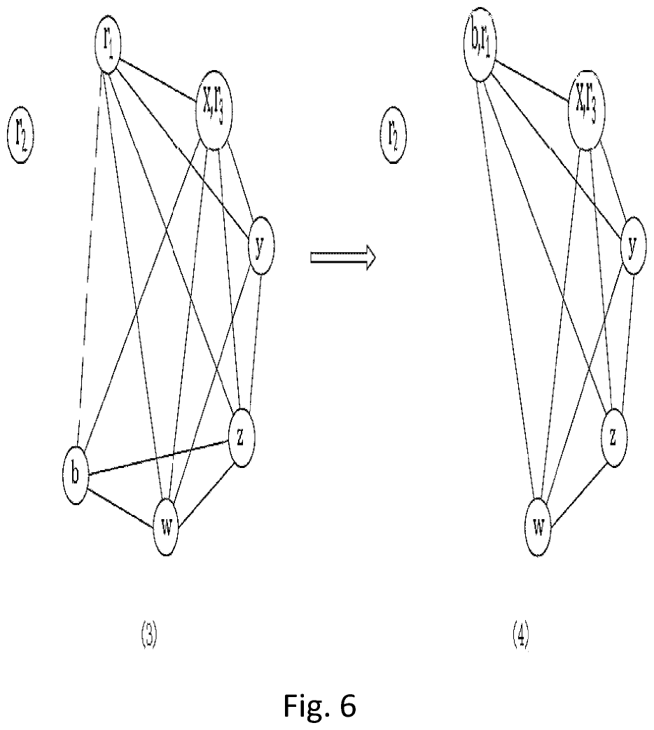

FIG. 6 shows a process of merging tensor variables r₁ and b, the life cycles of which have dotted lines, among the tensor variables included in the computational graph node, e.g., the process from (3) to (4) in FIG. 6.

In step 6, a tensor variable which goes beyond the number of idle registers and is not allocated to a register is iteratively cached into a memory. Iteratively caching the tensor variable which goes beyond the number of the idle registers and is not allocated to the register, into the memory includes the following processes:

in a first step, the life cycle of the tensor variable cached into the memory is analyzed; and

in a second step, the life cycle relationship graph of the tensor variables included in the computational graph node after the tensor variable is cached is updated.

Iteratively caching the tensor variable which goes beyond the number of the idle registers and is not allocated to the register, into the memory aim to give consideration to that the tensor variables b and x have been respectively allocated to physical registers r₁ and r₃ by the step of merging the tensor variables with the dotted lines, so that the register allocation operation is not carried out on the tensor variables b and x. The computational graph node includes three tensor variables in total and three registers are required. However, only one idle register r2 remains. Therefore, the tensor variable y needs to be stored in the memory first. Caching the tensor variable y which goes beyond the number of the idle registers and is not allocated to the register, into the memory includes the following processes.

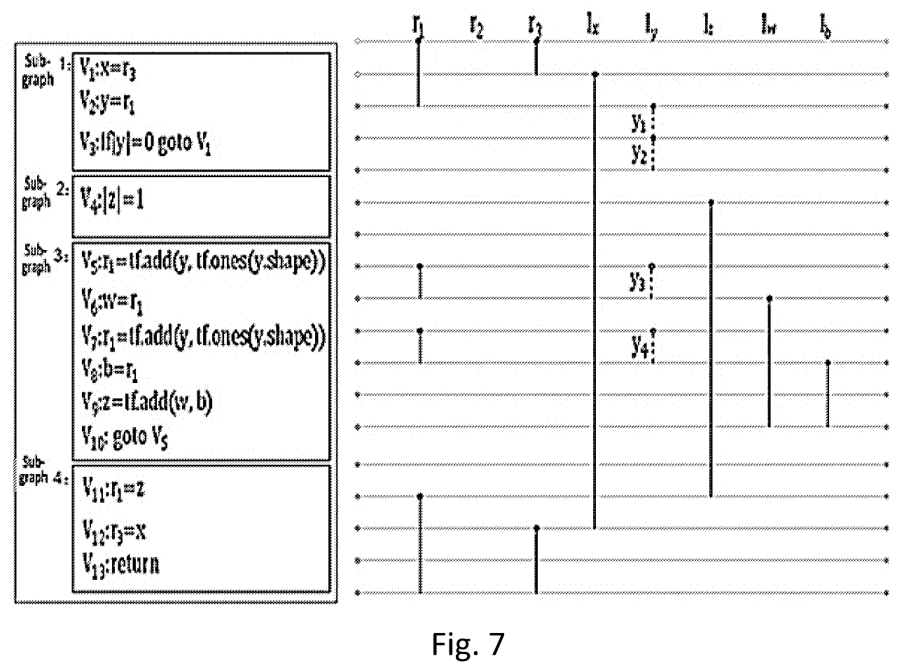

In a first step, the life cycle of the tensor variable cached into the memory is analyzed. FIG. 7 shows a process of analyzing the interval graph with respect to the life cycle after the tensor variable y which goes beyond the number of idle registers is cached into the memory.

In a second step, the life cycle relationship graph of the tensor variables included in the computational graph node after the tensor variable is cached is updated. Updating the life cycle relationship graph of the tensor variables included in the computational graph node after the tensor variable is cached includes the following two processes.

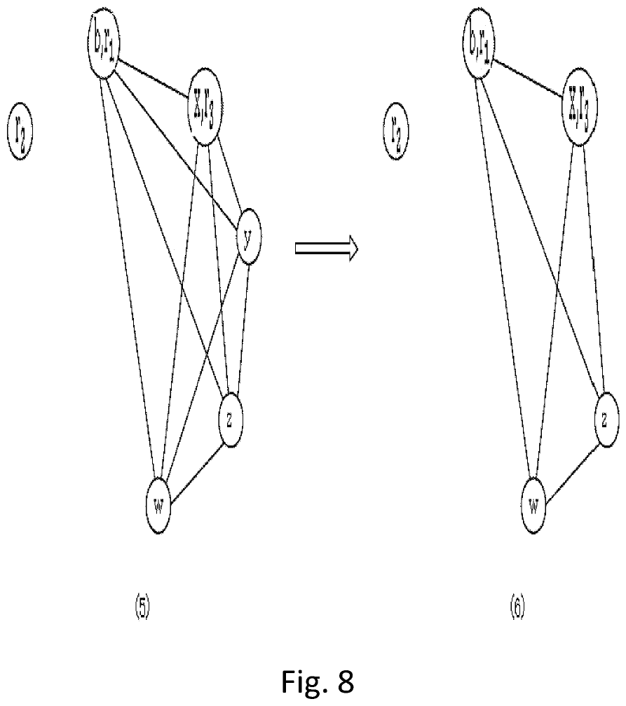

Firstly, a node representing the tensor variable y in the life cycle relationship graph of the tensor variables included in the computational graph node is deleted, and then a connecting edge with the node is also simultaneously deleted. FIG. 8 shows a process of deleting the node with the tensor variable cached into the memory and the connecting edge with the node, as shown from (5) to (6) in FIG. 8.

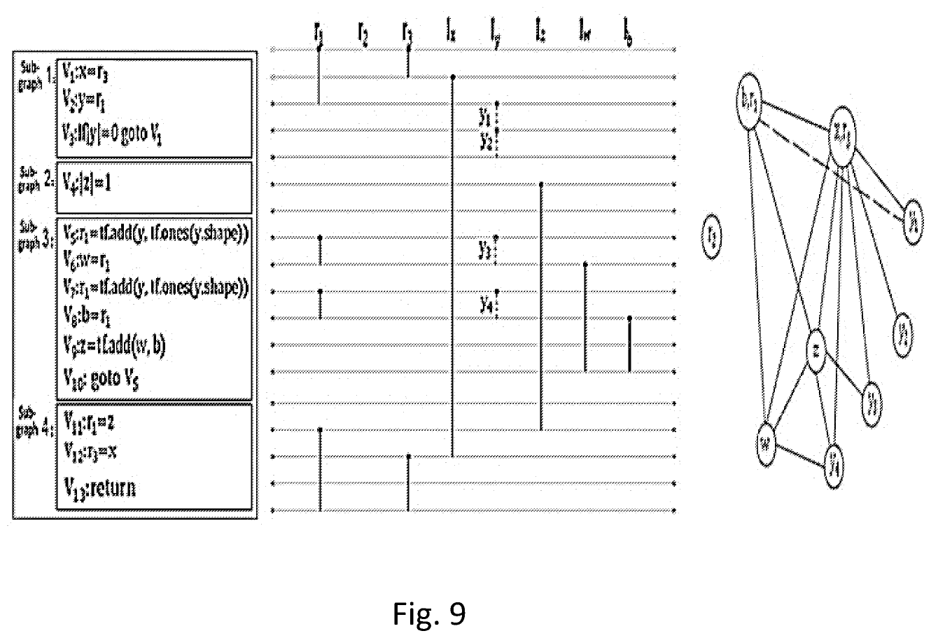

Secondly, the life cycle relationship graph is updated by the node including the cached tensor variable. FIG. 9 shows a process of updating the life cycle relationship graph by the node including the cached tensor variable as follows.
(1) A connecting edge of a node with a variable y₁ included at a computational graph node V₂ is constructed. The variable y₁ included at the computational graph node V₂ and a physical register r₁ have no life cycle conflict and have an assignment relationship, so that a dotted line connecting edge between the node including the variable y₁ and a node including the register r₁ is constructed. The variable y₁ and the variable x have a mutual life cycle conflict relationship, so that a solid line connecting edge between the node including the variable y₁ and a node including the variable x is constructed.
(2) A connecting edge of a node with a variable y₂ included at a computational graph node V₃ is constructed. The variable y₂ included at the computational graph node V₃ and the variable x have a mutual life cycle conflict relationship, so that a solid line connecting edge between the node including the variable y₂ and the node including the variable x is constructed.
(3) A connecting edge of a node with a variable y₃ included at a computational graph node V₅ is constructed. The variable y₃ included at the computational graph node V₅ has a mutual life cycle conflict relationship with both the variable x and a variable z, so that solid line connecting edges between the node including the variable y₃ and nodes respectively including the variable x and the variable z are constructed.
(4) A connecting edge of a node with a variable y₄ included in a computational graph node V₇ is constructed. The variable y₄ included at the computational graph node V₇ has a mutual life cycle conflict relationship with the variable x, the variable z, and a variable w, so that solid line connecting edges between the node including the variable y₄ and nodes respectively including the variable x, the variable z, and the variable w are constructed.

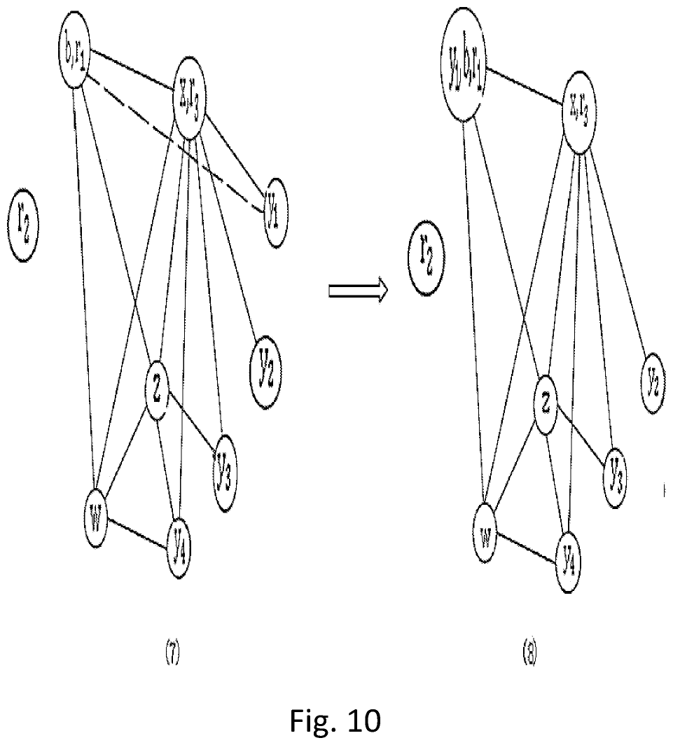

In a third step, tensor variables, the life cycles of which have dotted lines, among the tensor variables included in the computational graph node are merged, as shown in the process from (7) to (8) in FIG. 10.

For a case in which there is a tensor variable which goes beyond the number of the idle registers and is not allocated to the register, the above steps are repeated.

The life cycle relationship graph of the variables included in the computational graph node, is as shown in FIG. 10, which is obtained in step 6. The relationship graph indicates that there is the connecting edge between two nodes including the variables w and z, so that at least two different registers are required to be allocated to the variables w and z, but only one idle register r₂ remains. The physical registers r₁ and r₃ have been respectively allocated to the tensor variables y₁, b, and x, so that the tensor variables y₁, b, and x cannot be cached into the memory. Therefore, one of the tensor variables w and z needs to be cached into the memory. There are more connecting edges with the node including the variable z, so that it is considered that the tensor variable z is preferentially cached into the memory. Caching the tensor variable which goes beyond the number of the idle registers and is not allocated to the register, into the memory includes the following processes.

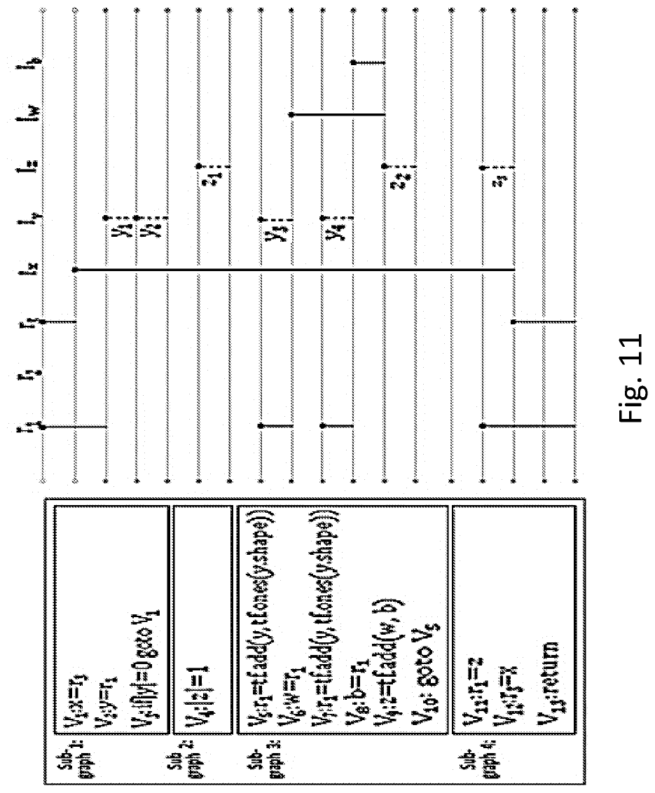

In a first step, the life cycle of the tensor variable cached into the memory is analyzed. FIG. 11 shows a process of analyzing the interval graph with respect to the life cycle after the tensor variable z which goes beyond the number of idle registers is cached into the memory.

In a second step, the life cycle relationship graph of the tensor variables included in the computational graph node after the tensor variable is cached is updated. Updating the life cycle relationship graph of the tensor variables included in the computational graph node after the tensor variable is cached includes the following two processes:

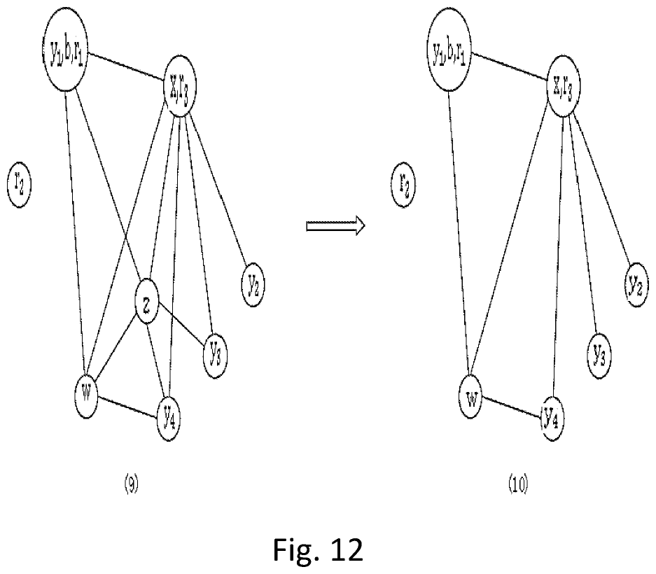

a node representing the tensor variable z in the life cycle relationship graph of the tensor variables included in the computational graph node is deleted, and then a connecting edge with the node is also simultaneously deleted. FIG. 12 shows a process of deleting the node with the tensor variable z cached into the memory and the connecting edge with the node, as shown in (9) to (10) in FIG. 12.

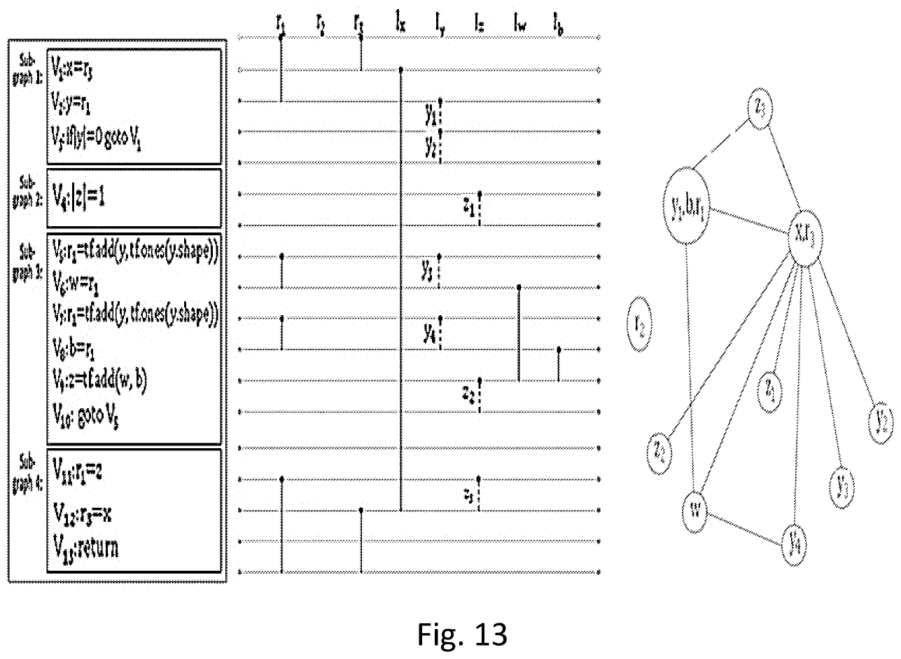

The life cycle relationship graph is updated by the node including the cached tensor variable. FIG. 13 shows a process of updating the life cycle relationship graph by utilizing the node including the cached tensor variable as follows.
(1) A connecting edge of a node with a variable z₁ included at a computational graph node V₄ is constructed. The variable z₁ included at the computational graph node V₄ and the variable x have a mutual life cycle conflict relationship, so that a solid line connecting edge between the node including the variable z₁ and the node including the variable x is constructed.
(2) A connecting edge of a node with a variable z₂ included at a computational graph node V₉ is constructed. The variable z₂ included at the computational graph node V₉ and the variable x have a mutual life cycle conflict relationship, so that a solid line connecting edge between the node including the variable z₂ and the node including the variable x is constructed.
(3) A connecting edge of a node with a variable z₃ included at a computational graph node V₁₁ is constructed. The variable z₃ included at the computational graph node V₁₁ and the variable x have a mutual life cycle conflict relationship, so that a solid line connecting edge between the node including the variable z₃ and the node including the variable x is constructed. Moreover, the variable z₃ and the physical register r₁ have no life cycle conflict and have an assignment relationship, so that a dotted line connecting edge between the node including the variable z₃ and the node including the physical register r₁ is constructed.

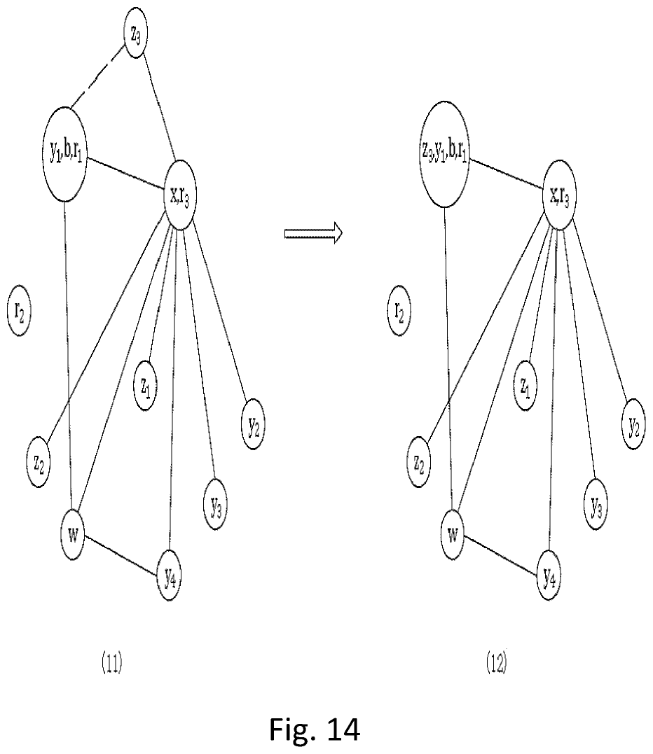

In a third step, the tensor variables, the life cycles of which have the dotted lines, among the tensor variables included in the computational graph node are merged, as shown in the process from (11) to (12) in FIG. 14.

As described above, until the tensor variables which go beyond the number of the idle registers and are not allocated to the registers are cached into the memory, the next step is performed.

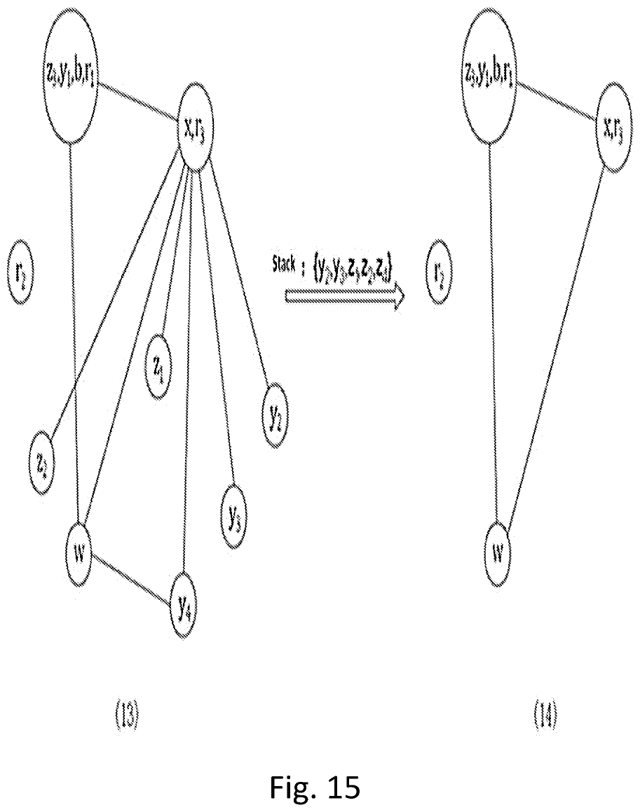

In step 7, a node with a degree smaller than the number of the registers in the life cycle relationship graph of the tensor variables included in the computational graph is transferred into a stack. The specific process of transferring the node with the degree smaller than the number of the registers in the life cycle relationship graph of the tensor variables included in the computational graph into the stack is as follows: sequentially transferring the node with the degree smaller than the number of the registers in the life cycle relationship graph into the stack, until only the nodes including the tensor variables, the number of which is equal to that of the idle registers, remain. FIG. 15 shows a process of transferring the node with the degree smaller than the number 3 of the registers into the stack.

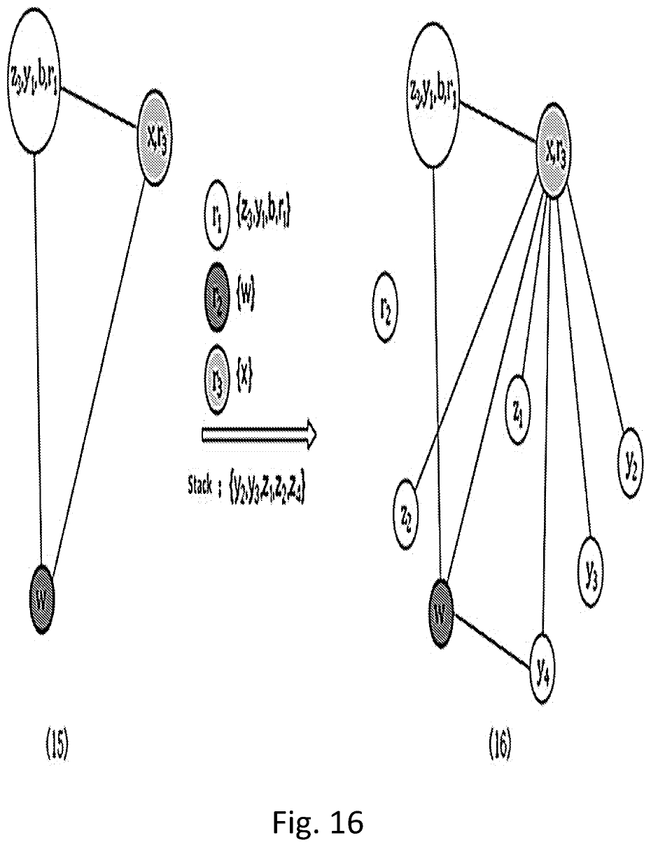

In step 8, the idle register is allocated to a variable included in a reserved node in the life cycle relationship graph. The process of allocating the idle register to the variable included in the reserved node in the life cycle relationship graph is as follows: allocating an idle register to a tensor variable which is not allocated to the register and included in the reserved node in the life cycle relationship graph. FIG. 16 shows a process of allocating the idle register to the variable w included in the reserved node in the life cycle relationship graph.

In step 9, a register is iteratively allocated to a tensor variable included in the node in the stack. The specific process of iteratively allocating the register to the tensor variable included in the node in the stack is as follows: iteratively allocating a register different from the adjacent node in the life cycle relationship graph to the tensor variable included in the stack where the node is cached. The sequence of allocating the register to the variable included in the node cached into the stack being a process of allocating the registers to the tensor variables sequentially according to a pop sequence of the nodes in the stack.

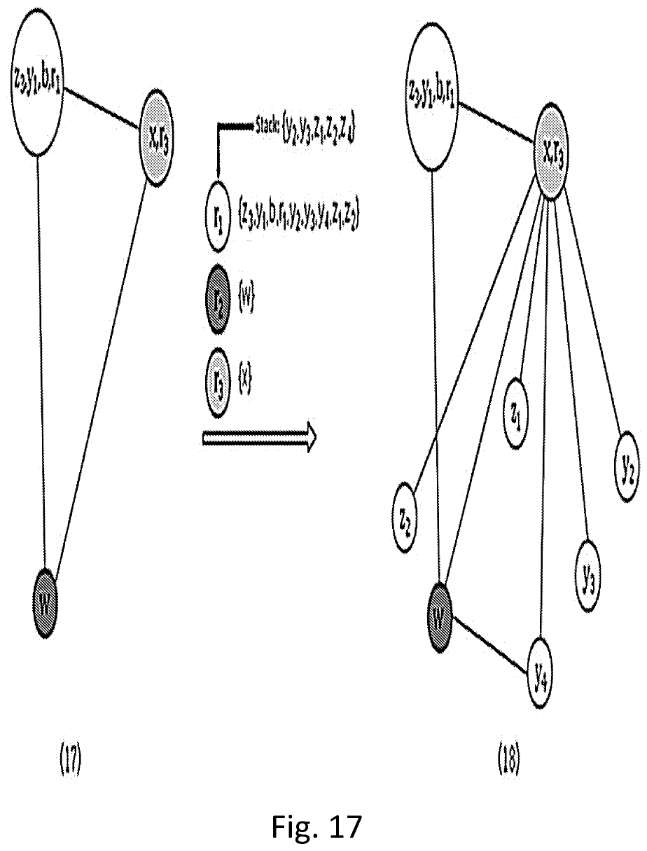

FIG. 17 shows a process of iteratively allocating the register to the variable included in the node cached into the stack. The tensor variables included in the node cached into the stack all have no connecting edges with the physical registers r₁ and r₂, so that any one of the registers r₁ and r₂ can be allocated to all the tensor variables in the stack. FIG. 16 shows a process of allocating the register r₁ to all the tensor variables in the stack.

As stated above, a method for optimizing memory allocation of dataflow in the computational graph generated by neural network compilation is provided, and it solves the problem of pre-allocating a memory to the tensor variable flowing through each node in the computational graph in the operation process by a deep learning operation system in a compiling phase. The present disclosure provides a method for analyzing the life cycle relationship among the tensor variables included in each node in the computational graph, and provides an optimization method for allocating the memories to the tensor variables included in the computational graph node by analyzing the life cycle relationship among the tensor variables. The memory optimization method not only promotes the execution efficiency of the computational graph in the operation process in future, but also reduces the overhead of the tensor variables for memory resources of the deep learning operation system. Therefore, the method for pre-allocating the memory to the tensor variable included in the computational graph node by means of analyzing the life cycle relationship among the tensor variables, optimizes the memory of the dataflow of the computational graph for neural network compilation, reduces the memory overhead required by the tensor variables in the dataflow, and lowers the requirement of a large model for hardware memory resources. Accordingly the computing efficiency of the overall computational graph is improved, and hardware and time cost is saved.

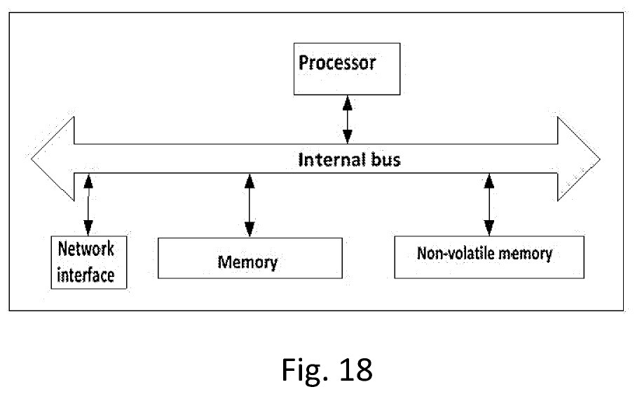

With reference to FIG. 18, an embodiment of the present disclosure further provides a memory optimization apparatus for neural network compilation, further including a memory and one or more processors. An executable code is stored in the memory, and when executing the executable code, the one or more processors are used for implementing the memory optimization method for neural network compilation in the embodiment above.

The embodiment of the memory optimization apparatus for neural network compilation provided by the present disclosure may be applied to any device with the data processing capability, and the any device with the data processing capability may be a device or an apparatus such as a computer. An apparatus embodiment may be implemented by software or may be implemented in a hardware or software-hardware combined mode. By taking implementation via software as an example, an apparatus in the logical sense is formed by reading, via a processor of any device with the data processing capability where the apparatus is located, a corresponding computer program instruction in a nonvolatile memory into a memory for operation. On the hardware level, as shown in FIG. 18, it is a hardware structural diagram of any device with the data processing capability where a memory optimization apparatus for neural network compilation provided by the present disclosure is located. Besides the processor, the memory, a network interface, and the nonvolatile memory shown in FIG. 18, any device with the data processing capability where the apparatus in the embodiment is located may further include other hardware according to actual functions of the any device with the data processing capability, which is not described in detail here. The implementing process of the function and the effect of each unit in the apparatus specifically refers to the implementing process of the corresponding step in the method, which is not described in detail here.

Since the apparatus embodiment basically corresponds to the method embodiment, the related description may refer to part of description in the method embodiment. The above-described apparatus embodiment is merely illustrative, wherein the unit described as a separation part may be or may not be physically separated, and a part for unit display may be or may not be a physical unit, i.e., may be located at one place, or may be distributed onto a plurality of network units. Part or all of modules can be selected according to actual demands to fulfill the aim of the solution of the present disclosure.

An embodiment of the present disclosure further provides a computer readable storage medium storing a program thereon. When the program is executed by a processor, the memory optimization method for neural network compilation in the above embodiment is implemented.

The computer readable storage medium may be an internal storage unit of the any device with the data processing capability according to any one of the above embodiments, e.g., a hard disk or a memory. The computer readable storage medium may also be an external storage device of any device with the data processing capability, e.g., an external hard drive, a Smart Media Card (SMC), a SD card, a flash card, etc. Further, the computer readable storage medium may also include not only the internal storage unit, but also the external storage device of the any device with the data processing capability. The computer readable storage medium is used for storing the computer program and other programs and data required by the any device with the data processing capability and may also be used for temporarily storing data which has been output or will be output.

The foregoing embodiments merely are preferred embodiments of the present disclosure, but not intended to limit the present disclosure. Any modifications, equivalent replacements, improvements and the like within the spirit and principle of the present disclosure shall fall within the scope of protection of the present disclosure.

1. A memory optimization method for neural network compilation, comprising:
compiling a neural network into a computational graph for neural network computation;
transforming the computational graph into a topological graph;
constructing a life cycle relationship graph of tensor variables in the computational graph;
analyzing a life cycle relationship among tensor variables in a node of the computational graph, by:
in the computational graph, connecting tensor variables whose life cycles overlap, among the tensor variables in the node by lines of a first type;
in the computational graph, connecting tensor variables whose life cycles do not overlap and that have an assignment relationship, among the tensor variables in the node by lines of a second type; and
in the computational graph, disconnecting tensor variables whose life cycles do not overlap, among the tensor variables in the node;
in the computational graph, iteratively merging tensor variables connected by lines of the second type and caching into a memory any tensor variable that goes beyond a number of idle registers of a processor of a computer system and is not allocated to any register of the processor, until all tensor variables that go beyond the number of the idle registers and are not allocated to any register of the processor are cached into the memory;
caching any node of the life cycle relationship graph with a degree smaller than a number of registers of the processor into a stack;
allocating one of the idle registers of the processor to a tensor variable that is not allocated to any register and is in a reserved node of the life cycle relationship graph;
iteratively allocating one of the registers of the processor to a tensor variable included in the node in the stack; and
configuring the computer system according to the life cycle relationship graph such that the computer system implements the neural network, thereby reducing requirement of memory of the computer system.

2. (canceled)

3. (canceled)

4. (canceled)

5. The memory optimization method for neural network compilation of claim 1, further comprising:
deleting any node of the life cycle relationship graph that has any tensor variable that goes beyond the number of the idle registers and is not allocated to any register; and
updating the life cycle relationship graph using a node including any cached tensor variable.

6. The memory optimization method for neural network compilation of claim 1, wherein caching the node with a degree smaller than the number of the registers comprises: sequentially pushing the node with a degree smaller than the number of the registers into the stack, until only those nodes including tensor variables whose number equals the number of the idle registers remain.

7. The memory optimization method for neural network compilation of claim 1, wherein iteratively allocating one of the registers to the tensor variable in the node in the stack comprises: iteratively allocating one of the registers different from that allocated to an adjacent node in the life cycle relationship graph to the tensor variable in the node in the stack.

8. A memory optimization apparatus for neural network compilation, comprising a non-transitory memory and one or more processors, wherein the non-transitory memory stores an executable code, and the one or more processors, when executing the executable code, implementing the memory optimization method for neural network compilation of claim 1.
